(19) United States
(12) Patent Application Publication
(10) Pub. No.: US 2016/0325488 A1
(43) Pub. Date: Nov. 10, 2016

(54) METHOD FOR JOINING METAL MEMBER WITH RESIN MEMBER, AND JUNCTION OF METAL MEMBER WITH RESIN MEMBER JOINED USING SAID METHOD

(71) Applicant: MAZDA MOTOR CORPORATION, Hiroshima (JP)

(72) Inventors: Koujirou TANAKA, Hiroshima-shi (JP); Katsuya NISHIGUCHI, Higashi-Hiroshima-shi (JP); Hirosuke SUMIDA, Hiroshima-shi (JP); Hiroyuki KAI, Hiroshima-shi (JP); Yushi MATSUDA, Higashi-Hiroshima-shi (JP); Yuki KODA, Hiroshima-shi (JP); Megumi KOBAYASHI, Hiroshima-shi (JP); Tsuguhisa MIYAMOTO, Aki-gun (JP); Yukihiro SUGIMOTO, Higashi-Hiroshima-shi (JP); Nobuo SAKATE, Hiroshima (JP)

(73) Assignee: MAZDA MOTOR CORPORATION, Hiroshima (JP)

(21) Appl. No.: 15/109,870

(22) PCT Filed: Jan. 7, 2015
(86) PCT No.: PCT/JP2015/000043

§ 371 Date: Jul. 6, 2016

(30) Foreign Application Priority Data
Jan. 14, 2014 (JP) 2014-004379

(51) Int. Cl. B29C 65/06; B29C 65/00; B23K 20/233; B23K 20/12; B23K 20/227

(52) U.S. Cl. CPC B29C 65/0681; B23K 20/1265; B23K 20/129; B23K 20/1255; B23K 20/227; B23K 20/2333; B29C 66/7422; B29C 66/1122; B23K 2201/18

(57) ABSTRACT

In thermal pressure joining of joining a metal member to a resin member, a metal member (11) and a resin member (12) are stacked one on the other, a press member (160) applies heat and pressure locally on the metal member to soften and melt the resin member, the resin member is then solidified, the press member (160) is pressed into the metal member (11) to a depth shallower than a joint boundary (13) between the metal and resin members to deform a portion (110) of the metal member directly under the press member such that the portion protrudes toward the resin member, and resin (121) melted on a surface of the resin member in a region (60) of the joint boundary directly under the press member flows to an outer periphery (61) of the region (60).

### TECHNICAL FIELD

The present disclosure relates to a method of joining a metal member to a resin member, and a joint body of the metal and resin members joined by the method.

### BACKGROUND ART

Conventionally, light weighting has been required in the fields of vehicles, railroad vehicles, and aircrafts, for example. In the field of vehicles, for example, the thicknesses of steel plates are reduced by utilizing high-tensile steel. In place of steel materials, aluminum alloys are used. Furthermore, resin materials is also being used. In these fields, development in the technique of joining a metal member to a resin member is important in view of not only light weighting of a vehicle body but also higher strength, stiffness, and productivity of a joint body. As a method of joining a metal member to a resin member, what is called friction-stir welding (FSW) was suggested. The friction-stir welding is, as shown in FIG. 7, as follows. A metal member 211 and a resin member 212 are stacked one on the other. A rotating rotary tool 216 is pressed into the metal member 211 to generate frictional heat, which melts the resin member 212. The resin member 212 is then solidified to be jointed to the metal member 211. In FIG. 7, continuous welding is performed while moving the rotary tool 216. However, spot welding may be performed without moving the rotary tool 216.

In such friction-stir welding, a technique of determining the form of a rotary tool or setting the amount of pressing within a specified range is suggested in view of joint strength and simple joining, for example (e.g., Patent Document 1).

### CITATION LIST

### Patent Document

[PATENT DOCUMENT 1] Japanese Unexamined Patent Publication No. 2010-158885

### SUMMARY OF THE INVENTION

### Technical Problem

However, in conventional friction-stir welding, the pressing force of the rotary tool 216 on the metal member 211 is relatively small. Thus, as shown in FIGS. 8A and 8B, the amount of pressing is also relatively small. As a result, the frictional heat is insufficiently conducted to the resin member 212 to inefficiently melt the resin member 212. This causes deterioration in the work efficiency needed to obtain sufficient joint strength. Specifically, even if a region 260 of the resin member 212 directly under a press member 216 is melted at a joint boundary 213 between the metal and resin members 211 and 212, an outer periphery 261 is hardly melted and the melted resin hardly flows into the outer periphery 261. Even if the outer periphery 261 is melted, the amount is too small to obtain sufficient joint strength. In order to obtain sufficient joint strength, a longer pressing time is considered, which lowers the work efficiency in welding. On the other hand, greater pressing force is also considered, which may cause early penetration of the rotary tool through the metal and resin members 211 and 212 to hinder welding.

It is an object of the present disclosure to provide a method of joining a metal member to a resin member with sufficiently high work efficiency and sufficient strength, and a joint body of the metal and resin members joined by the method.

### Solution to the Problem

The present disclosure provides a method of joining a metal member to a resin member comprising a pressing step. The method is thermal pressure joining In the pressing step, the metal and resin members are stacked one on the other, a press member applies heat and pressure locally on the metal member to soften and melt the resin member, the resin member is then solidified, the press member is pressed into the metal member to a depth shallower than a joint boundary between the metal and resin members to deform a portion of the metal member directly under the press member such that the portion protrudes toward the resin member, and resin melted on a surface of the resin member in a region of the joint boundary directly under the press member flows to an outer periphery of the region.

The present disclosure also provides friction-stir welding including a first step of stacking the metal and resin members one on the other, and a second step of joining the metal member to the resin member by pressing a rotating rotary tool into the metal member to generate frictional heat, softening and melting the resin member with the frictional heat, and then solidifying the resin member. The second step includes a press stirring step. In the press stirring step, the rotary tool is pressed into the metal member to the depth shallower than the joint boundary between the metal and resin members to deform a portion of the metal member directly under the rotary tool such that the portion protrudes toward the resin member, and resin melted on a surface of the resin member in a region of the joint boundary directly under the rotary tool flows to an outer periphery of the region.

The present disclosure also provides a metal-resin joint body of the metal and resin members obtained by any one of the methods described above.

### Advantages of the Invention

The joining method according to the present disclosure joins a resin member to a metal member with sufficiently high work efficiency and sufficient strength.

### BRIEF DESCRIPTION OF THE DRAWINGS

FIG. 1 schematically illustrates a part of an exemplary friction-stir welding apparatus suitable for a method of joining a metal member to a resin member.

FIG. 2 is an enlarged view of an end of an exemplary rotary tool used in the joining method of an embodiment.

FIG. 3 is a general cross-sectional view illustrating a preheating step in the joining method of the embodiment.

FIG. 4A is a general cross-sectional view illustrating a press stirring step, a continuous stirring step, and a holding step in the joining method of the embodiment. FIG. 4B is a general schematic view illustrating the state of the surface of the resin member of FIG. 4A as viewed from above through the metal member.

FIG. 5A is a general cross-sectional view of a joint body obtained by the joining method according to this embodiment. FIG. 5B is a general schematic view illustrating the state of the surface of the resin member after forcibly peeling the metal member off the joint body of FIG. 5A.

FIG. 6 generally illustrates measurement of joint strength in the embodiment.

FIG. 7 is a general sketch illustrating a method of joining a metal member to a resin member according to prior art.

FIG. 8A is a general cross-sectional view illustrating a method of joining a metal member to a resin member according to prior art. FIG. 8B is a general schematic view illustrating the state of the surface of the resin member of FIG. 8A as viewed from above through the metal member.

### DESCRIPTION OF EMBODIMENTS

### Embodiment

The joining method according to an embodiment is thermal pressure joining of joining a metal member to a resin member. The metal and resin members are stacked one on the other. A press member applies heat and pressure locally on the metal member to soften and melt the resin member. The resin member is then solidified. The type of joining employed in the joining method is not limited, as long as the press member applies heat and pressure locally on the metal member. For example, it may be friction-stir welding, and ultrasonic heat-bonding. The friction-stir welding is preferably employed.

The friction-stir welding is, as will be described later, a joining method utilizing frictional heat generated by pressing a rotating rotary tool into a metal member.

The ultrasonic heat-bonding is a joining method utilizing frictional heat between metal and resin members caused by ultrasonic vibrations generated in the metal member by applying pressure on the metal member.

The joining method of this embodiment, which employs the friction-stir welding, will be described below with reference to the drawings. The ultrasonic heat-bonding is the same as or similar to the friction-stir welding except the following. The ultrasonic heat-bonding clearly provides the same advantages as the friction-stir welding of this embodiment.
Instead of applying pressure and heat using a rotary tool, pressure is applied using a press member and heat is applied by vibrating the press member.
Instead of the diameter of the rotary tool, the width of the press member is used.

### [Friction-Stir Welding of Joining Metal Member to Resin Member]

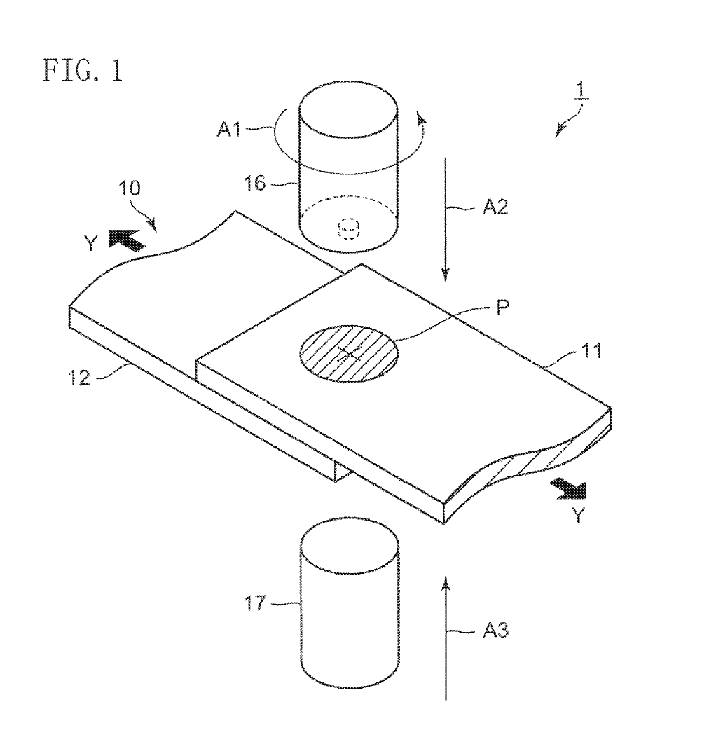

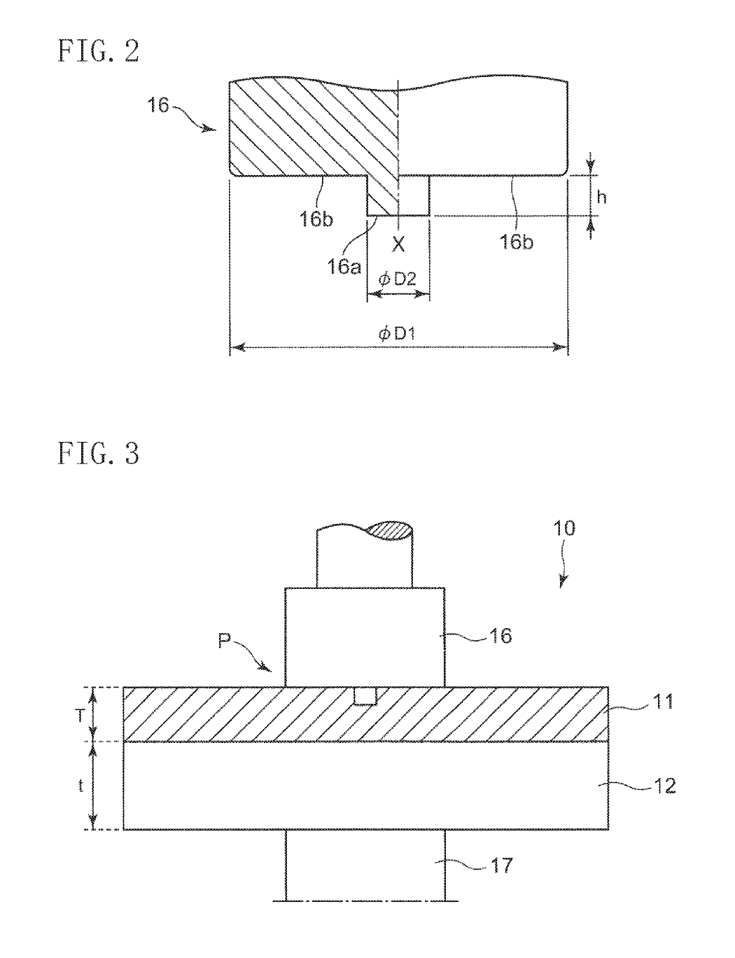

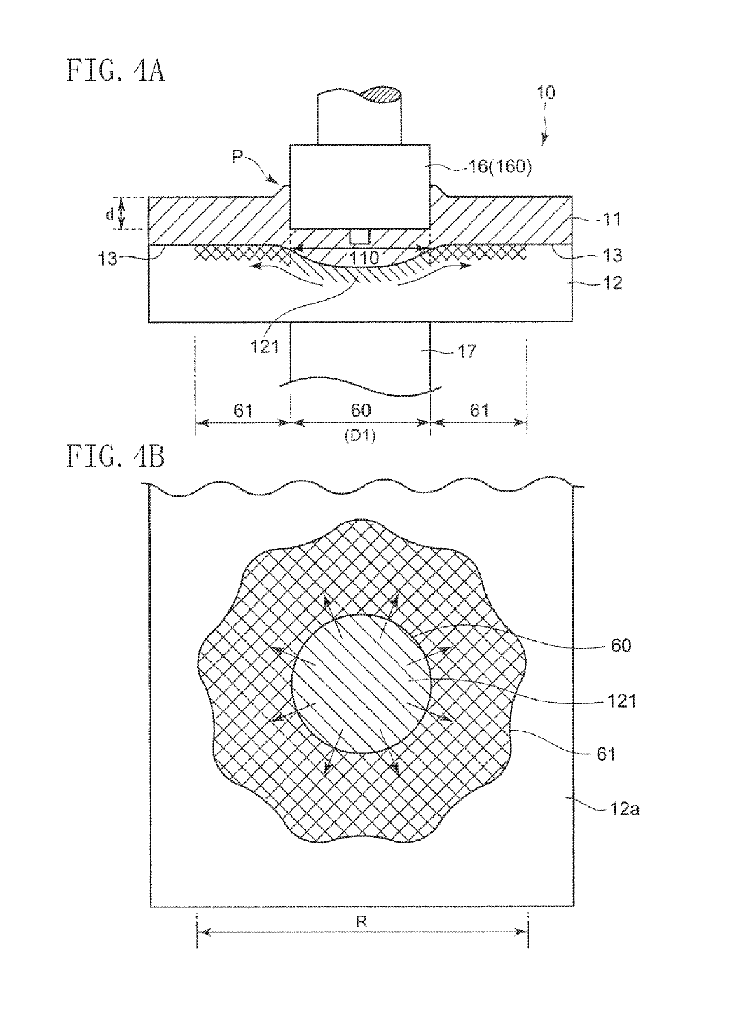

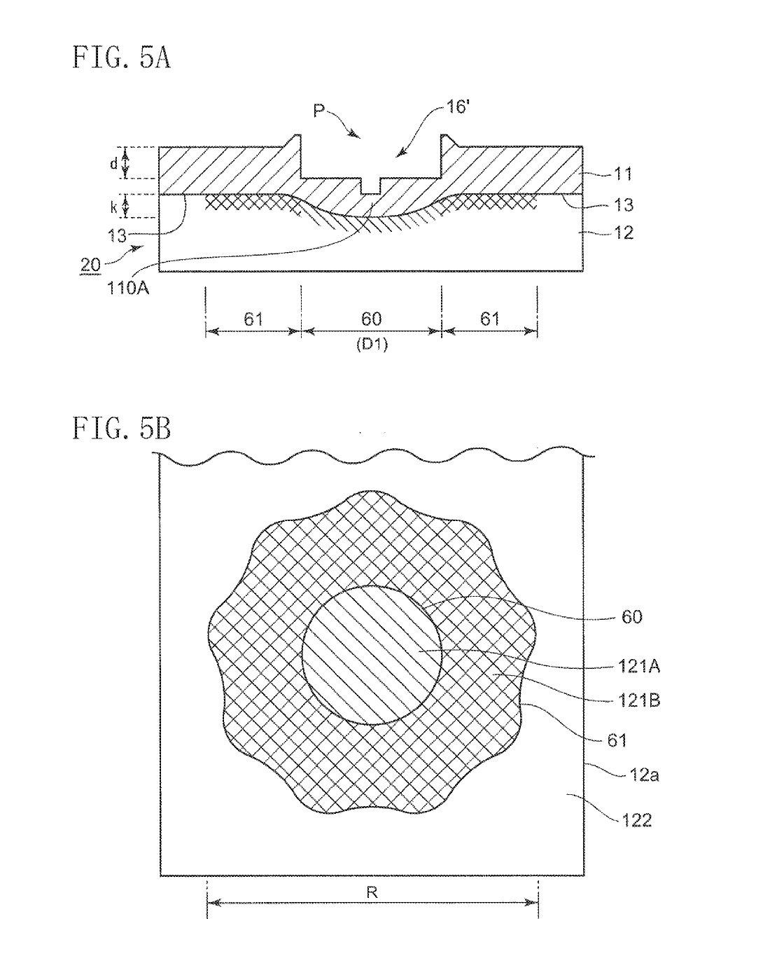

The joining method (i.e., the friction-stir welding) of this embodiment will be described in detail with reference to FIGS. 1-5B. FIG. 1 schematically illustrates a part of an exemplary friction-stir welding apparatus suitable for the method of joining a metal member to a resin member according to this embodiment. FIG. 2 is an enlarged view of an end of an exemplary rotary tool used in the joining method according to an embodiment. FIG. 3 is a general cross-sectional view illustrating a preheating step in the joining method of this embodiment. FIG. 4A is a general cross-sectional view illustrating a press stirring step, a continuous stirring step, and a holding step in the joining method of this embodiment. FIG. 4B is a general schematic view illustrating the state of the surface of the resin member of FIG. 4A as viewed from above through the metal member. FIG. 5A is a general cross-sectional view of a joint body obtained by the joining method according to this embodiment. FIG. 5B is a general schematic view illustrating the state of the surface of the resin member after forcibly peeling the metal member off the joint body of FIG. 5A. In these drawings, the same reference characters are used to represent equivalent elements.

### (1) Joining Apparatus

First, FIG. 1 schematically illustrates a part of the exemplary friction-stir welding apparatus suitable for the joining method according to this embodiment. A friction-stir welding apparatus 1 shown in FIG. 1 joints a metal member 11 to a resin member 12 by friction-stir welding, and is provided with a columnar rotary tool 16. As shown in the figure, the rotary tool 16 is rotated by a drive source (not shown) around the central axis X (see FIG. 2) of the rotary tool 16 in the direction of an arrow A1. The rotating rotary tool 16 presses a pressed region P (i.e., a region to be pressed) of the metal member 11 of a work 10 downward as indicated by an arrow A2. The work 10 is formed by stacking the metal member 11 on the resin member 12. This pressing of the rotary tool 16 generates frictional heat, which is conducted to the resin member 12 to soften and melt the resin member 12. The resin member 12 is then solidified by cooling. As a result, the metal member 11 is joined to the resin member 12.

FIG. 2 is the enlarged view of the end of the rotary tool 16. In FIG. 2, the right half shows the outer appearance of the rotary tool 16, and the left half shows the cross-section. As shown in FIG. 2, the columnar rotary tool 16 includes a pin portion 16a and a shoulder portion 16b at the end (at the bottom in FIG. 2). The shoulder portion 16b is the end portion of the rotary tool 16 including a circular end surface of the rotary tool 16. The pin portion 16a is a columnar portion protruding outward (downward in FIG. 2) beyond the circular end surface of the rotary tool 16 along the central axis X of the rotary tool 16 and having a smaller diameter than the shoulder portion 16b. The pin portion 16a is for positioning the rotary tool 16 when the rotating rotary tool 16 first touches and presses the work 10.

The material of the rotary tool 16 and the sizes of the portions are mainly determined based on the type of metal used for the metal member 11 which is pressed by the rotary tool 16. For example, if the metal member 11 is made of an aluminum alloy, the rotary tool 16 is made of tool steel (e.g., SKD61), the shoulder portion 16b has a diameter D1 of 10 mm, the pin portion 16a has a diameter D2 of 2 mm, and the protrusion of the pin portion 16a has a length h of 0.5 mm For example, if the metal member 11 is made of steel, the rotary tool 16 is made of silicon nitride or polycrystalline cubic boron nitride (PCBN), the shoulder portion 16b has a diameter D1 of 10 mm, the pin portion 16a has a diameter D2 of 3 mm, and the protrusion of the pin portion 16a has a length h of 0.5 mm. Indeed, these values are mere examples and the present disclosure is clearly not limited thereto. For example, although the shoulder portion 16b usually has a diameter D1 of 5-30 mm, preferably 5 to 15 mm, the present disclosure is not limited thereto.

A columnar receiving tool 17 is located below the rotary tool 16 coaxially with the rotary tool 16. The receiving tool 17 has a diameter greater than or equal to that of the rotary tool 16. The receiving tool 17 is moved by the drive source (not shown) upward as indicated by an arrow A3 toward the work 10. The top of the receiving tool 17 touches the bottom of the work 10 (precisely the bottom of the resin member 12) at latest until the rotary tool 16 starts pressing of the work 10. The receiving tool 17 sandwiches the work 10 together with the rotary tool 16, and supports the work 10 from the bottom against the pressure while the work 10 is pressed by the rotary tool 16, that is, while the friction-stir welding. The receiving tool 17 does not necessarily move in the direction of the arrow A3, the rotary tool 16 may move to the direction of the arrow A2 after the work 10 is mounted on the receiving tool 17.

The friction-stir welding apparatus 1 is mounted on a drive controller (not shown) such as an articulated robot. The drive controller controls the coordinate positions of the rotary tool 16 and the receiving tool 17, and the rotational speed (rpm), pressure (N), pressing time (sec) of the rotary tool 16 properly. Although not shown in FIG. 1, the friction-stir welding apparatus 1 includes jigs such as spacers and cramps to fix the work 10 in advance and to reduce floating of the metal member 11 when the rotary tool 16 is pressed into the metal member 11.

### (2) Joining Method

The joining method according to this embodiment includes at least the following steps: a first step of stacking the metal and resin members 11 and 12 one on the other; and a second step of joining the metal member 11 to the resin member 12 by pressing the rotating rotary tool 16 into the metal member 11 to generate frictional heat, softening and melting the resin member 12 with this frictional heat, and then solidifying the resin member 12.

The stack of the metal and resin members 11 and 12 obtained in the first step is referred to as the work 10.

First Step

In the first step, as shown in FIG. 1, the metal and resin members 11 and 12 are stacked one on the other at a desired joint position.

Second Step

The second step includes at least a press stirring step C2, in which the rotary tool 16 is pressed into the metal member 11 to a depth shallower than a joint boundary 13 between the metal and resin members 11 and 12 to deform a portion 110 of the metal member 11 directly under the rotary tool such that the portion 110 protrudes toward the resin member.

In this embodiment, in the second step, a preheating step C1 is preferably performed before the press stirring step to rotate the rotary tool 16 with only its end touching the surface of the metal member 11. The preheating step C1 is however not necessarily performed.

After the press stirring step, a continuous stirring step C3 is preferably performed to continue the rotation of the rotary tool 16 in the depth shallower than the joint boundary. The continuous stirring step C3 is however not necessarily performed.

The respective steps will now be described in detail.

### Preheating Step C1

In the preheating step C1, the rotary tool 16 and the receiving tool 17 come close to each other, and the rotary tool 16 rotates, as shown in FIG. 3, with only its end touching the surface (the upper surface in the figure) of the metal member 11. In the preheating step C1, the rotary tool 16 rotates at a first pressure (e.g., 900 N) at a predetermined rotational speed (e.g., 3000 rpm) for a first pressing time (e.g., 1.00 secs).

Specifically, in the preheating step C1, the pressing of the rotary tool 16 generates frictional heat on the surface (the upper surface in the figure) of the metal member 11. This frictional heat is conducted into the metal member 11 to preheat the pressed region P of the metal member 11 and its periphery. This facilitates the pressing of the rotary tool 16 into the metal member 11 in the next press stirring step C2.

In the preheating step C1, the frictional heat is conducted to the resin member 12 via the joint boundary 13 between the metal and resin members 11 and 12. The frictional heat is conducted into the resin member 12 to preheat the region 60 of the resin member 12 directly under the pressed region P and the periphery of the region 60. This facilitates softening and melting of the resin member 12 in the next press stirring step C2.

In the preheating step C1, the first pressure and the first pressing time are determined in view of easy pressing of the rotary tool 16 and easy softening and melting of the resin member 12 as well as the productivity. These values vary depending on, for example, the rotational speed of the rotary tool 16, and the thickness and material of the metal member 11. For example, if the metal member 11 is made of an aluminum alloy and has a thickness of 1-2 mm, the first pressure in the preheating step C1 is preferably higher than or equal to 700 N and lower than 1200 N. The first pressing time is preferably longer than or equal to 0.5 secs and shorter than 2.0 secs. The rotational speed of the rotary tool preferably falls within a range from 2000 rpm to 4000 rpm.

### Press Stirring Step C2

In the press stirring step C2, the rotary tool 16 and the receiving tool 17 come close to each other, and the rotary tool 16 is pressed into the metal member 11 as shown in FIG. 4A. If the press stirring step C2 follows the preheating step C1, the rotary tool 16 and the receiving tool 17 come closer to each other, and the rotary tool 16 is pressed into the metal member 11 as shown in FIG. 4A. This allows the rotary tool 16 to reach the depth shallower than the joint boundary 13 between the metal and resin members 11 and 12 to deform the portion 110 of the metal member 11 directly under the rotary tool such that the portion 110 protrudes toward the resin member 12. This accelerates melting of the resin on the surface of the resin member 121 in the region 60 of the joint boundary 13 directly under the rotary tool and flow of the melted resin to the outer periphery 61 of the region 60.

Specifically, in the press stirring step C2, the rotary tool 16 rotates at a second pressure (e.g., 1500 N) higher than the first pressure at a predetermined rotational speed (e.g., 3000 rpm) for a second pressing time (e.g., 0.25 secs) shorter than the first pressing time.

The pressure in the press stirring step C2 is higher than the pressure in the preheating step C1 to press the rotary tool 16 into the metal member 11. That is, the rotary tool 16 reaches deep inside the metal member 11. This pressing of the rotary tool 16 moves, at the portion 110 of the metal member 11 directly under the rotary tool, the joint boundary 13 between the metal and resin members 11 and 12 toward the receiving tool 17 (downward in the figure) to deform the portion 110 such that the portion 110 protrudes toward the resin member 12. This accelerates the melting of the resin on the surface of the resin member 121 in the region 60 of the joint boundary 13 directly under the rotary tool, and allows the melted resin to flow over the region 60 to its outer periphery 61. The melted resin spreads, as shown in FIG. 4B for example, in a substantial circular shape around the region 60 directly under the rotary tool. This results in an increase in the contact area between the melted resin and the metal member 11. This also increases a melted and solidified region (i.e., a joint region) of the joint body obtained by cooling and solidifying the melted resin. Therefore, the resin member is joined to the metal member with sufficiently high work efficiency and sufficient strength. The melted and solidified region (i.e., the joint region) here includes a part of the outer periphery 61, which is directly melted by heating the touched metal surface.

If the rotary tool 16 is further pressed (i.e., if the pressure is too high and/or if the pressing time is too long), the shoulder portion 16b of the rotary tool 16 exceeds the joint boundary. Specifically, the rotary tool 16 penetrates the metal member 11 so that the outer periphery of the rotary tool 16 touches the resin member 12. Then, a hole, thorough which the rotary tool 16 passes, is open in the metal member 11, thereby causing joint defects.

To address this problem, in this embodiment, the pressing of the rotary tool 16 stops when the shoulder portion 16b of the rotary tool 16 reaches the depth shallower than the joint boundary in the press stirring step C2. In other words, the rotary tool 16 reaches the depth shallower than the joint boundary. Then, in the next continuous stirring step C3, frictional heat is generated in a reference position close to the resin member 12, and a large amount of frictional heat is conducted to the resin member 12 to accelerate softening and melting of the resin member 12.

In the press stirring step C2, the pressing depth d of the rotary tool 16 (see FIG. 4A) usually falls within a range from 0.5 T to 0.9 T, preferably from 0.5 T to 0.7 T, where the metal member 11 has a thickness T (mm) If the pressing depth d is too small, the portion 110 of the metal member 11 directly under the rotary tool is not or slightly (if any) deformed to protrude. This hinders a sufficient increase in the contact area between the melted resin and the metal member 11, and thus a desired joint strength is not obtained. The pressing depth d is easily measured from a cross-sectional picture of a joint body 20 which is obtained eventually. In this specification, the cross-section is a cross-section perpendicular to the metal member 11 passing through a rotary tool trace 16′ (see FIG. 5A).

In the press stirring step C2, the second pressure and the second pressing time are determined in view of reducing the opening in the metal member 11 and bringing the rotary tool 16 as close as possible to the resin member 12. These values vary depending on, for example, the rotational speed of the rotary tool 16, and the thickness and material of the metal member 11. For example, if the metal member 11 is made of an aluminum alloy and has a thickness of 1-2 mm, the second pressure in the press stirring step C2 is preferably higher than or equal to 1200 N and lower than 1800 N. The second pressing time is preferably longer than or equal to 0.1 secs and shorter than 0.5 secs. The rotational speed of the rotary tool preferably falls within a range from 2000 rpm to 4000 rpm.

### Continuous Stirring Step C3

In the continuous stirring step C3, the rotary tool 16 and the receiving tool 17 stop coming close to each other to continue the rotation of the rotary tool 16 in the depth (hereinafter referred to as a “reference position”) shallower than the joint boundary 13 as shown in FIG. 4A. In the continuous stirring step C3, the rotary tool 16 rotates at a third pressure (e.g., 500 N) lower than the first pressure at a predetermined rotational speed (e.g., 3000 rpm) for a third pressing time (e.g., 5.75 secs) longer than the first pressing time.

In the continuous stirring step C3, the pressure is lower than that in the preheating step C1 (clearly lower than that in the press stirring step C2) so that the rotary tool 16 is maintained almost in the reference position. Since the rotation of the rotary tool 16 is maintained in the reference position close to the resin member 12, a large amount of frictional heat is generated, and most of the generated frictional heat moves to the resin member 12. The resin member 12 is thus sufficiently softened and melted in a large area over the region 60 directly under the pressed region P.

In the continuous stirring step C3, the third pressure and the third pressing time are determined in view of sufficient softening and melting of the resin member 12 in such a large area and productivity. These values vary depending on, for example, the rotational speed of the rotary tool 16, and the thickness and material of the metal member 11. For example, if the metal member 11 is made of an aluminum alloy and has a thickness of 1-2 mm, the third pressure in the continuous stirring step C3 is preferably higher than or equal to 100 N and lower than 700 N. The third pressing time is preferably longer than or equal to 1.0 sec and shorter than 20 secs, particularly, within a range from 3.0 to 10 secs. The rotational speed of the rotary tool preferably falls within a range from 2000 rpm to 4000 rpm.

### Holding Step C4

After the continuous stirring step C3, a holding step C4 may be performed, in which the rotation of the rotary tool 16 stops and, in this stopped state, the rotary tool 16 is held at a predetermined pressure for a predetermined pressing time.

In the holding step C4, also as shown in FIG. 4A, the rotation of the rotary tool 16 stops, and in this state, the rotary tool 16 is held at a predetermined pressure for a predetermined time. In the holding step C4, the rotary tool 16 is held at a fourth pressure (e.g., 1000 N) higher than the third pressure but lower than the second pressure for a fourth pressing time (e.g., 5.00 secs) shorter than the third pressing time but longer than the second pressing time.

In the holding step C4, the rotation of the rotary tool 16 stops to finish generating the frictional heat. Specifically, the substantial operation of the friction-stir welding ends and the cooling of the work 10 starts. During the cooling of the work 10, the pressure is lower than that in the press stirring step C2, but higher than that in the continuous stirring step C3. The rotary tool 16, whose rotation stops, cramps the pressed region P of the metal member 11 together with the receiving tool 17. This improves adhesiveness between the metal and resin members 11 and 12 during the cooling, and increases the joint strength after the end of cooling and solidification.

In the holding step C4, the fourth pressure and the fourth pressing time are determined in view of improving the adhesiveness in the pressed region P during the cooling. These values vary depending on, for example, the material of the metal member 11. For example, if the metal member 11 is made of an aluminum alloy, the fourth pressure in the holding step C4 is preferably higher than or equal to 700 N and lower than 1200 N. The fourth pressing time is preferably longer than or equal to 1.0 sec.

In this embodiment, at least after passing through the step C2, preferably the steps C1 and C2, more preferably steps C1-C3, and as necessary the step C4, the joint body 20 is eventually obtained, in which the metal member 11 is joined to the resin member 12 with high strength in a large area as shown in FIG. 5A.

In the second step, after a predetermined step(s), cooling is usually performed to solidify the melted resin. How to cool is not particularly limited, and for example, leaving cooling or air cooling may be performed.

An example has been described where the metal member is joined to the resin member in a point (point joining) without continuously moving the rotary tool along the contact surface with the metal member. The advantages of this embodiment are also clearly obtained where the metal member is joined to the resin member linearly (linear joining) while continuously moving the rotary tool along the contact surface.

### (3) Joint Body

In the joint body 20 obtained by the joining method of this embodiment, the metal member 11 is joined to the resin member 12 in the region 60 of the resin member 12 at the joint boundary 13 directly under the rotary tool and its outer periphery 61. This fact is detected by determining that the melted and solidified region obtained by solidifying the melted resin at the joint boundary 13 of the joint body 20 spreads in a substantial circular shape around the region 60 directly under the rotary tool.

Specifically, when the metal member 11 is forcibly peeled off the joint body 20, for example, a contact surface 12a of the resin member 12 is observed, which is in contact with the metal member 11, in FIG. 5B. In the contact surface 12a of the resin member 12, the melted and solidified region is comprised of a resin melt region 121A (i.e., the shadow region) in the region 60 directly under the rotary tool and a melted resin flowing region 121B (i.e., the lattice region) in the outer periphery 61 of the region 60.

The surface of the resin melt region 121A is recessed by the protrusion and deformation of the metal member 11. The recess has a diameter almost equal to the diameter of the rotary tool. An uneven pattern on the surface of the metal member 11 is transferred on the surface of the resin melt region 121A. The color of the surface of the resin melt region 121A could change depending on the joint strength. The resin melt region 121A is thus easily visually recognized as compared with the surface properties (e.g., roughness and color) of the original resin member 12. Only the surface properties of the resin member 12 are compared, and the roughness and color largely depending on the type of resin and the molding method are not particularly defined. If the resin member 12 is continuous fiber-reinforced resin, the melted resin component near the surface is discharged from the resin melt region 121A to the melted resin flowing region 121B and only the continuous reinforcing fibers could be exposed on the surface of the resin melt region 121A.

The uneven pattern on the surface of the metal member 11 is transferred on the surface of the melted resin flowing region 121B. The color of the surface of the melted resin flowing region 121B could change depending on the joint strength. The melted resin flowing region 121B is thus easily visually recognized as compared with the surface properties (e.g., roughness and color) of the original resin member 12. Only the surface properties of the resin member 12 are compared, and the roughness and color largely depending on the type of resin and the molding method are not particularly defined. The melted resin flowing region 121B includes not only the melted resin having flown from the resin melt region 121A, but also the part of the outer periphery 61, in which the resin is directly melted by touching the heated metal surface.

On the surface 12a of the resin member 12 in contact with the metal member 11, a non-melted region 122 is adhered to the surface of the metal member 11 only by pressure. After peeling, the surface properties (e.g., roughness and color) of the original resin member 12 are retained. Therefore, as described above, the large differences between the melted resin flowing region 121B and the original resin member 12 in surface properties are easily visually determined.

The joint body 20 according to this embodiment satisfies the relation below, where the melted and solidified regions (121A and 121B) have a maximum diameter R (mm), and the rotary tool has a diameter of D1 (mm)

1<R/D1≦9;

preferably 1.5≦R/D1≦7; and

more preferably 2≦R/D1≦5.

If R/D1 is too small, the joint strength is insufficient. An increase in R/D1 leads to a longer joining time (i.e., a decrease in the productivity). The melted resin flows out of a possible flow area of the melted resin (e.g., the width of a flange to be processed) to cause a bury. It is thus important to adjust R/D1 within a range suitable for the required strength of a part to be processed and the environment. The maximum diameter of the melted and solidified regions (121A and 121B) is usually equal to the maximum radius of the melted resin flowing region 121B.

The diameter R of the melted and solidified regions (121A and 121B) is easily measured by observing the surface 12a of the resin member 12 in contact with the metal member 11 as follows.

The joint body 20 according to this embodiment also includes a protrusion 110A on the surface of the metal member 11 in contact with the resin member 12. The protrusion 110A usually has a height k (see FIG. 5A) of 0.2 T−1.0 T, preferably 0.3 T−0.8 T, where the metal member 11 has a thickness T (mm)

### (4) Resin Member

The resin member 12 used in the joining method of this embodiment is made of plastic polymer. Any type of thermoplastic polymer may be used as a component of the resin member 12. Out of them, the thermoplastic polymer used in the field of vehicles is preferably used. Specific examples of such thermoplastic polymer are the following polymer and their mixtures:

polyolefin-based resin such as polyethylene and polypropylene, and its acid-modified resin;

polyester-based resin such as polyethylene terephthalate (PET), polybutylene terephthalate (PBT), polytrimethylene terephthalate (PTT), and polylactic acid (PLA);

polyacrylate-based resin such as polymethyl methacrylate (PMMA);

polyether-based resin such as polyether ether ketone (PEEK) and polyphenylene ether (PPE);

polyacetal (POM);

polyphenylene sulfide (PPS);

polyamide (PA)-based resin such PA6, PA66, PA11, PA12, PA6T, PA9T, and MXD6;

polycarbonate (PC)-based resin;

polyurethane-based resin;

fluorine-based polymer resin; and

liquid crystal polymer (LCP).

The thermoplastic polymer as the component of the resin member 12 is preferably polyolefin-based resin, which is available at low cost and has excellent mechanical characteristics. In view of improving the joint strength, carboxylic acid-modified polyolefin-based resin is preferably used. In view of further improving the strength of the resin member itself and the joint strength, a mixture of carboxylic acid-modified polyolefin-based resin and unmodified polyolefin-based resin is preferably used. The ratio of the carboxylic acid-modified polyolefin-based resin and the unmodified polyolefin-based resin may be 15/85-45/55, particularly, 20/80-40/60 by weight.

The carboxylic acid-modified polyolefin-based resin is polymer obtained by introducing a carboxyl group into the main chain and/or side chain of a polyolefin molecular chain. The carboxylic acid-modified polyolefin is preferably graft copolymer obtained by grafting unsaturated carboxylic acid on the main chain of polyolefin.

The polyolefin as a component of the carboxylic acid-modified polyolefin-based resin is homopolymer, copolymer, or a mixture of at least one of olefin monomer selected from the group of α-olefin consisting of ethylene, propylene, butene, pentene, hexene, heptene, or octane. The polyolefin is preferably polypropylene.

The unsaturated carboxylic acid as a component of the carboxylic acid-modified polyolefin-based resin is acrylic acid, methacrylic acid, itaconic acid, fumaric acid, maleic acid, maleic anhydride, or their mixture. The unsaturated carboxylic acid is preferably maleic acid, maleic anhydride, or their mixture, and more preferably maleic anhydride.

The amount of modification of the carboxylic acid-modified polyolefin is not particularly limited, but preferably falls within a range from 0.01% to 1%.

The amount of modification is calculated as a weight ratio of the unsaturated carboxylic acid to the entire polymer.

The molecular weight of the carboxylic acid-modified polyolefin-based resin is not particularly limited, but is preferably carboxylic acid-modified polyolefin with a melt flow rate (MFR) of, for example, 2.0 g/10 min or higher, particularly 5.0 g/10 min or higher at 230° C.

In this specification, the MFR of the polymer is measured under JIS K 7210.

The carboxylic acid-modified polyolefin-based resin is, for example, commercially available MODIC P565 (Mitsubishi Chemical Corporation) or MODIC P553A (Mitsubishi Chemical Corporation).

The unmodified polyolefin-based resin is equivalent to the polymer described as the polyolefin being the component of the carboxylic acid-modified polyolefin-based resin. The unmodified polyolefin is preferably polypropylene.

The molecular weight of the unmodified polyolefin is not particularly limited, but is preferably unmodified polyolefin with an MFR of, for example, 2-200 g/10 min, particularly 2-55 g/10 min at 230° C.

The unmodified polyolefin is, for example, commercially available NOVATEC FY6 (Japan Polypropylene Corporation, homopolypropylene, with an MFR of 2.5), NOVATEC MA3 (Japan Polypropylene Corporation, homopolypropylene, with an MFR of 11), NOVATEC MA1B (Japan Polypropylene Corporation, homopolypropylene, with an MFR of 21).

A specific exemplary combination of the carboxylic acid-modified polyolefin-based resin and the unmodified polyolefin-based resin is as follows:

carboxylic acid-modified polypropylene/homopolypropylene.

An example has been described where the resin member 12 as a whole is in a substantial plate-like form. The present disclosure is not limited thereto. As long as the portion of the resin member 12 directly under the metal member 11 is in a substantial plate-like form when being stacked under the metal member 11 for joining, the resin member 12 may be in any form.

The portion of the resin member 12 directly under the metal member 11 usually has a thickness t (thickness before joining, see FIG. 3) of 2-5 mm, the present disclosure is not limited thereto.

The resin member 12 may contain other desired addictive such as reinforcing fibers, stabilizer, flame retardant, colorant, and a blowing agent. Out of them, the reinforcing fibers are preferably contained. This is because the reinforcing fibers improve the efficiency in melting the resin member 12 at the joint boundary 13, resulting in further improvement in the work efficiency to obtain sufficient joint strength.

The content of reinforcing fibers is not particularly limited, but preferably falls within a range from 1 pts. wt. to 400 pts. wt., particularly from 1 pts. wt. to 150 pts. wt. based of 100 pts. wt. of thermoplastic polymer as the component of the resin member 12.

### (5) Metal Member

In FIG. 1, for example, the metal member 11 as a whole is in a substantial plate-like form. The present disclosure is not limited thereto. As long as at least the portion of the metal member 11 stacked on the resin member 12 for joining is in a substantial plate-like form, the metal member 11 may be in any form.

The plate-like portion of the metal member 11 stacked on the resin member 12 usually has a thickness T (thickness before joining, see FIG. 3) of 0.5-4 mm The present disclosure is not limited thereto.

The metal member 11 may be made of any metal with a higher melting point than the thermoplastic polymer as the component of the resin member 12. Out of them, the following metal and alloys used in the field of vehicles are preferably used:

aluminum;

a series 5000 or 6000 aluminum alloy;

steel;

magnesium and its alloy; and

titanium and its alloy.

### EXAMPLES

### Example 1A

### Resin Member

As polymer A, maleic anhydride modified polypropylene (with an MFR of 5.7) was used. The amount of modification was about 0.5%.

As polymer B, NOVATEC FY6 (Japan Polypropylene Corporation, homopolypropylene, with an MFR of 2.5) was used.

The resin member 12 with a height of 100 mm×a width of 30 mm×a depth of 3 mm was fabricated by injection molding of the polymer A and B. Specifically, 50 pts. wt. of polymer A and 50 pts. wt. of the polymer B were heated to 230° C. to obtain a molten mixture. The molten mixture was injected into a mold controlled at 40° C. at a speed of 50 mm/sec, and then cooled and solidified to obtain the resin member 12.

### Metal Member

As the metal member, a plate-like member of a series 6000 aluminum alloy with a thickness of 1.2 mm was used.

### Rotary Tool

A rotary tool of tool steel in the following sizes in FIG. 2 was used:

D1=10 mm,

D2=2 mm, and

H=0.5 mm

### Joining Method

The joint body of the metal and resin members 11 and 12 was fabricated by the following method.

### First Step:

An end of the metal member 11 and an end of the resin member 12 were stacked one on the other as shown in FIG. 1.

### Second Step:

As shown in FIG. 3, the rotary tool 16 rotates (in the preheating step C1: at a pressure of 900 N at a rotational speed of 3000 rpm for a pressing time of 1.00 sec) with only its end touching the surface of the metal member 11.

Then, as shown in FIG. 4, the rotary tool 16 was pressed into the metal member 11 to the depth shallower than the joint boundary between the metal and resin members 11 and 12 (in the press stirring step C2: at a pressure of 1500 N at a rotational speed of 3000 rpm for a pressing time of 0.25 secs).

After that, as shown in FIG. 4, the rotation of the rotary tool 16 continues in the depth shallower than the joint boundary (in the continuous stirring step C3: at a pressure of 500 N at a rotational speed 3000 rpm for a pressing time 0.75 secs).

Then, as shown in FIG. 5A, the rotary tool 16 was taken out of the joint body 20 and the joint body was left and cooled.

### Joint Strength

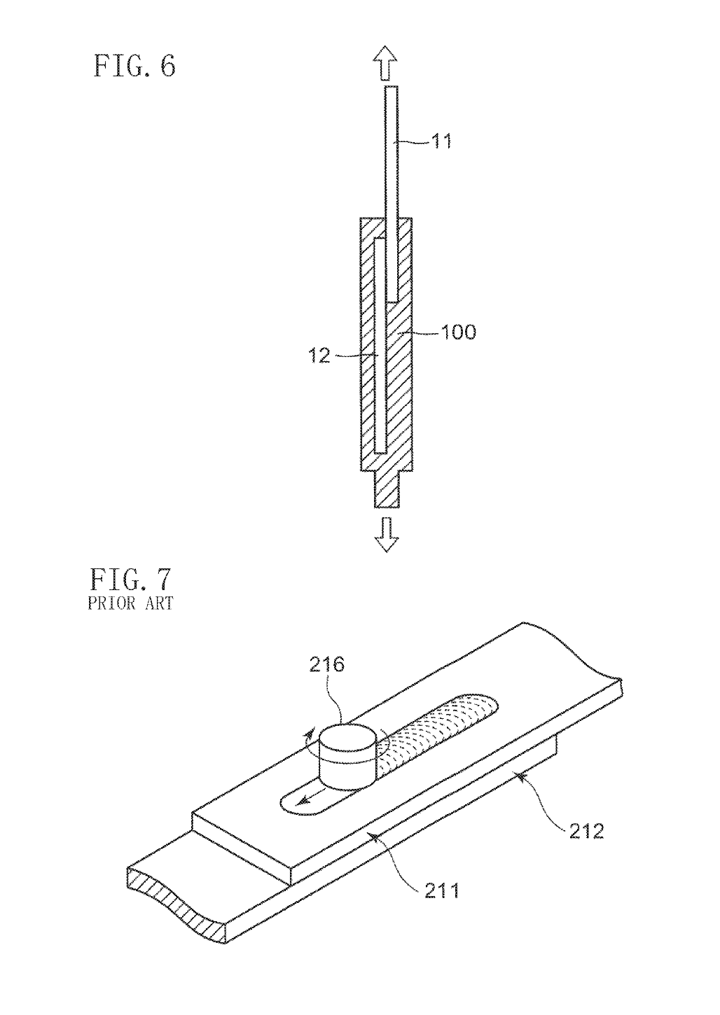

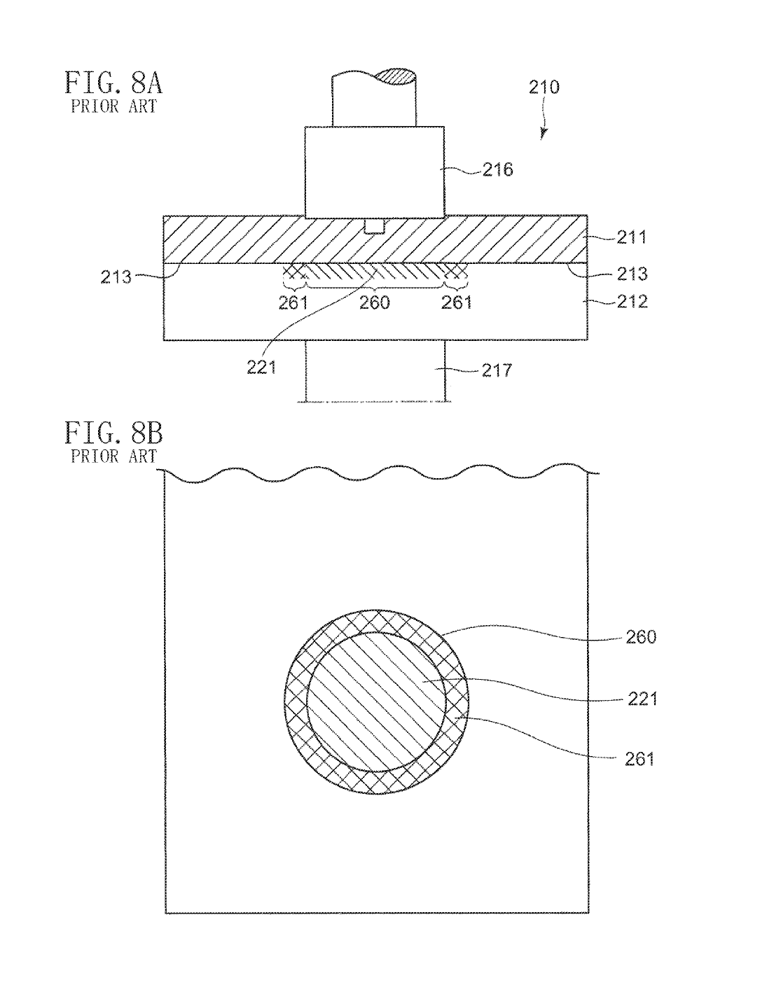

As shown in FIG. 6, the joint body of the metal and resin members 11 and 12 was located in a jig 100. When the jig 100 is pulled downward, downward force is applied to the top of the resin member 12. When the jig 100 is fixed and the metal member 11 is pulled upward, downward force is applied to the top of the resin member 12. This allows measurement of the shearing strength of the joint without being influenced by the strength of the base material of the resin member 1.

### (Other Measurements)

The diameter R of the melted and solidified region was measured by the method described above to calculate R/D1.

The pressing depth d was measured by the method described above to calculate d/T.

The protrusion height k was measured by the method described above to calculate k/T.

### Other Examples and Comparative Examples

The processing conditions were changed as indicated in the table. Otherwise, the resin member was fabricated and assessed in the same manner as Example 1A.

TABLE 1

| | Conditions | | | | | | | | | | | |
|---|---|---|---|---|---|---|---|---|---|---|---|---|
| | Time (secs) | | | | Pressure (N) | | | Rotational | | Shearing | | |
| | Step | Step | Step | | Step | Step | Step | Speed | | Strength | | |
| | C1 | C2 | C3 | Total | C1 | C2 | C3 | (rpm) | R/D1 | (kN) | d/T | k/T |
| Example 1A | 1.00 | 0.25 | 0.75 | 2.00 | 900 | 1500 | 500 | 3000 | 2.01 | 0.85 | 0.5 | 0.6 |
| Comparative Example 1A | 2.00 | — | — | 2.00 | 900 | — | — | 3000 | 1.45 | 0.50 | 0.1 | 0.0 |
| Example 2A | 1.00 | 0.25 | 2.75 | 4.00 | 900 | 1500 | 500 | 3000 | 3.02 | 1.59 | 0.5 | 0.6 |
| Comparative Example 2A | 4.00 | — | — | 4.00 | 900 | — | — | 3000 | 2.07 | 0.87 | 0.1 | 0.0 |
| Example 3A | 1.00 | 0.25 | 4.75 | 6.00 | 900 | 1500 | 500 | 3000 | 3.98 | 2.71 | 0.5 | 0.6 |
| Comparative Example 3A | 6.00 | — | — | 6.00 | 900 | — | — | 3000 | 2.84 | 1.40 | 0.1 | 0.0 |
| Comparative Example 3B | 6.00 | — | — | 6.00 | 1500 | — | — | 3000 | 0.00 | 0.00 | 1.0 | — |
| Example 4A | 1.00 | 0.25 | 6.75 | 8.00 | 900 | 1500 | 500 | 3000 | 4.56 | 3.11 | 0.6 | 0.7 |
| Comparative Example 4A | 8.00 | — | — | 8.00 | 900 | — | — | 3000 | 3.23 | 1.82 | 0.2 | 0.1 |
| Example 5A | 1.00 | 0.25 | 8.75 | 10.00 | 900 | 1500 | 500 | 3000 | 4.78 | 3.67 | 0.6 | 0.7 |
| Comparative Example 5A | 10.00 | — | — | 10.00 | 900 | — | — | 3000 | 3.35 | 1.94 | 0.2 | 0.1 |
| Example 6A | 1.00 | 0.25 | 10.75 | 12.00 | 900 | 1500 | 500 | 3000 | 4.96 | 4.05 | 0.7 | 0.8 |
| Comparative Example 6A | 12.00 | — | — | 12.00 | 900 | — | — | 3000 | 3.48 | 2.07 | 0.2 | 0.1 |

R/D1 is a ratio of the diameter of a melted and solidified region to the diameter of a rotary tool.
d/T is a ratio of a pressing depth to the thickness of a metal member.
k/T is a ratio of the height of a protrusion to the thickness of the metal member.

In Examples 1A-6A, the melted and solidified region is significantly large relative to the joining time such that the resin member is joined to the metal member with sufficient strength and sufficiently high work efficiency.

In Comparative Examples 1A-6A, the melted and solidified region was too small relative to the joining time.

In Comparative Example 3B, the tool penetrates the work and reaches the resin too early to perform joining

### INDUSTRIAL APPLICABILITY

The joining method according to the present disclosure is useful to join a metal member to a resin member in the fields of vehicles, railroad vehicles, aircrafts, and home appliances, for example.

### DESCRIPTION OF REFERENCE CHARACTERS

1 Friction-Stir Welding Apparatus
10 Work
11 Metal Member
12 Resin Member
13 Joint Boundary between Metal and Resin Members
16 Rotary Tool
17 Receiving Tool
20 Joint Body
60 Region Directly under Rotary Tool
61 Outer Periphery of Region Directly under Rotary Tool
100 Jig for Measuring Joint Strength
110 Portion of Metal Member Directly under Rotary Tool
121 Resin Melted in Region of Joint Boundary Directly Under Rotary Tool
121A Resin Melt Region Constituting Melted and Solidified Region Obtained by Solidifying Melted Resin
121B Melted Resin Flowing Region Constituting Melted and Solidified Region Obtained by Solidifying Melted Resin
P Region of Surface of Metal Member Pressed (Region to Be Pressed) by Rotary Tool

1. A method of joining a metal member to a resin member comprising a pressing step, wherein
the method is thermal pressure joining, and
in the pressing step,
the metal and resin members are stacked one on the other,
a press member applies heat and pressure locally on the metal member to soften and melt the resin member,
the resin member is then solidified,
the press member is pressed into the metal member to a depth shallower than a joint boundary between the metal and resin members to deform a portion of the metal member directly under the press member such that the portion protrudes toward the resin member,
resin melted on a surface of the resin member in a region of the joint boundary directly under the press member flows to an outer periphery of the region,
the method is friction-stir welding including
a first step of stacking the metal and resin members one on the other, and
a second step of joining the metal member to the resin member by pressing a rotating rotary tool into the metal member to generate frictional heat, softening and melting the resin member with the frictional heat, and then solidifying the resin member,
the rotating rotary tool is used as the press member,
the second step includes
the pressing step as a press stirring step, and
before the press stirring step, a preheating step of rotating the rotary tool with only its end touching a surface of the metal member,
in the preheating step, the rotary tool is pressed at a first pressure and rotates for a first pressing time, and
in the press stirring step, the rotary tool is pressed at a second pressure higher than the first pressure and rotates for a second pressing time shorter than the first pressing time.

2. The method of claim 1, wherein
the press member is pressed into the metal member such that protrusion of the metal member toward the resin member has a height k of 0.2 T to 1.0 T, where the metal member has a thickness of T (mm).

3. The method of claim 1, wherein
the metal member is joined to the resin member at the joint boundary in the region of the resin member directly under the press member and its outer periphery.

4. The method of claim 1, wherein an obtained joint body of the metal and resin members satisfies
1<R/D1≦9,
where a melted and solidified region obtained by solidifying the melted resin at the joint boundary spreads in a substantial circular shape around the region directly under the press member, the melted and solidified region has a diameter of R (mm), and the press member has a width of D1 (mm).

5. The method of claim 1, wherein
the resin member contains reinforcing fibers.

6-8. (canceled)

9. The method of claim 1, wherein
the second step further includes a continuous stirring step of continuing rotation of the rotary tool in the depth shallower than the joint boundary, and
in the continuous stirring step, the rotary tool is pressed at a third pressure lower than the first pressure and rotates for a third pressing time longer than the first pressing time.

10. The method of claim 9, wherein
the second step further includes, after the continuous stirring step, a holding step of stopping the rotation of the rotary tool and holding the rotary tool in this stopped state at a predetermined pressure for a predetermined pressing time.

11. (canceled)

12. The method of claim 2, wherein
the metal member is joined to the resin member at the joint boundary in the region of the resin member directly under the press member and its outer periphery.

13. The method of claim 2, wherein
an obtained joint body of the metal and resin members satisfies
1<R/D1≦9,
where a melted and solidified region obtained by solidifying the melted resin at the joint boundary spreads in a substantial circular shape around the region directly under the press member, the melted and solidified region has a diameter of R (mm), and the press member has a width of D1 (mm).

14. The method of claim 2, wherein the resin member contains reinforcing fibers.

15. The method of claim 2, wherein
the second step further includes a continuous stirring step of continuing rotation of the rotary tool in the depth shallower than the joint boundary, and
in the continuous stirring step, the rotary tool is pressed at a third pressure lower than the first pressure and rotates for a third pressing time longer than the first pressing time.

16. The method of claim 15, wherein
the second step further includes, after the continuous stirring step, a holding step of stopping the rotation of the rotary tool and holding the rotary tool in this stopped state at a predetermined pressure for a predetermined pressing time.

17. The method of claim 3, wherein
an obtained joint body of the metal and resin members satisfies
1<R/D1≦9,
where a melted and solidified region obtained by solidifying the melted resin at the joint boundary spreads in a substantial circular shape around the region directly under the press member, the melted and solidified region has a diameter of R (mm), and the press member has a width of D1 (mm).

18. The method of claim 3, wherein the resin member contains reinforcing fibers.

19. The method of claim 3, wherein
the second step further includes a continuous stirring step of continuing rotation of the rotary tool in the depth shallower than the joint boundary, and
in the continuous stirring step, the rotary tool is pressed at a third pressure lower than the first pressure and rotates for a third pressing time longer than the first pressing time.

20. The method of claim 19, wherein
the second step further includes, after the continuous stirring step, a holding step of stopping the rotation of the rotary tool and holding the rotary tool in this stopped state at a predetermined pressure for a predetermined pressing time.
